(19) United States
(12) Patent Application Publication
(10) Pub. No.: US 2026/0328630 A1
(43) Pub. Date: Oct. 22, 2026

(54) APPARATUS AND METHOD FOR ANALYZING STRAIN OR TEMPERATURE OF OPTICAL FIBER

(71) Applicant: NTT, Tokyo (JP)

(72) Inventors: Tatsuyai OKAMOTO, Musashino-shi, Tokyo (JP); Daisuke IIDA, Musashino-shi, Tokyo (JP); Yusuke KOSHIKIYA, Musashino-shi, Tokyo (JP)

(73) Assignee: NTT, Tokyo (JP)

(21) Appl. No.: 19/106,780

(22) PCT Filed: Sep. 29, 2022
(86) PCT No.: PCT/JP2022/036489

§ 371 Date: Feb. 26, 2025

(51) Int. Cl. G01L 1/24; G01K 11/32

(52) U.S. Cl. CPC G01L 1/242; G01K 11/32

(57) ABSTRACT

The present disclosure is an analysis device that analyzes distribution waveforms of beat signals obtained by combining backscattered light from an optical fiber obtained by injection of probe light, out of the probe light and local light obtained by split of frequency-swept light, into the optical fiber, with the local light, in which the analysis device calculates frequency offsets existing at two different points of the optical fiber by using cross-correlation between backscattered light waveforms obtained from the beat signals measured at different times; and measure strain or temperature of an analysis section, connecting the two different points, by calculating a difference between the frequency offsets existing at the two different points.

### TECHNICAL FIELD

The present disclosure relates to an optical fiber sensing technique.

### BACKGROUND ART

There has been proposed optical time domain reflectometry distributed acoustic sensing (OTDR-DAS) in which strain caused by physical vibration of an optical fiber under measurement or temperature of the optical fiber is measured in a distributed manner, in a longitudinal direction of the optical fiber, using optical time domain reflectometry (OTDR) in which pulse test light is injected into the optical fiber and backscattered light caused by Rayleigh scattering is detected (see, for example, Non Patent Literature 1).

In order to faithfully measure strain or temperature in accordance with OTDR-DAS, satisfaction of a phase unwrapping condition (equivalent to sampling theorem) is necessary. In addition, the longer the gauge length of the optical fiber under measurement of strain or temperature is, the smaller a temporal change amount of the phase needs to be. For this reason, the gauge length of the optical fiber under measurement of strain or temperature has limitation that depends on the temporal change amount of the phase.

### CITATION LIST

### Non Patent Literature

Non Patent Literature 1: Hartog, Arthur H. An introduction to distributed optical fibre sensors. CRC press, 2017.
Non Patent Literature 2: Okamoto, Tatsuya, Daisuke Iida, and Hiroyuki Oshida. “Vibration-induced beat frequency offset compensation in distributed acoustic sensing based on optical frequency domain reflectometry.” Journal of Lightwave Technology 37.18 (2019): 4896-4901.

### SUMMARY OF INVENTION

### Technical Problem

An object of the present disclosure is to enable measurement of strain or temperature of an analysis section having any length without limitation regarding a maximum temporal change amount of a phase subject to the measurement.

### Solution to Problem

Specifically, a measurement system of the present disclosure includes:
a frequency-swept light source that outputs frequency-swept light;
an optical splitting part that splits the frequency-swept light into probe light and local light;
an optical combining part that combines backscattered light obtained by injection of the probe light into the optical fiber with the local light; and
the analysis device of the present disclosure that analyzes a beat signal obtained by the combination.

The analysis device of the present disclosure executes an analysis method of the present disclosure. An analysis method of the present disclosure is an analysis method executed by an analysis device that analyzes distribution waveforms of beat signals obtained by combining backscattered light from an optical fiber obtained by injection of probe light, out of the probe light and local light obtained by split of frequency-swept light, into the optical fiber, with the local light, the analysis method including:
calculating frequency offsets existing at two different points of the optical fiber by using cross-correlation between backscattered light waveforms obtained from the beat signals measured at different times; and
measuring strain or temperature of an analysis section, connecting the two different points, by calculating a difference between the frequency offsets existing at the two different points.

According to the present disclosure, the analysis device may calculate a cumulative frequency modulation amount of the analysis section connecting the two different points by calculating the difference between the frequency offsets existing at the two different points; and calculate the strain or temperature using the calculated cumulative frequency modulation amount.

According to the present disclosure, the analysis section may be modified by changing a position of at least one of the two points of the optical fiber; and an origin of vibration of the optical fiber may be discovered on ground of an increase or a decrease in cumulative frequency modulation amount of the modified analysis section.

Note that the above-described disclosures can be combined in any possible manner.

### Advantageous Effects of Invention

The present disclosure can enable measurement of strain or temperature of an analysis section having any length without limitation regarding a maximum temporal change amount of a phase subject to the measurement.

### BRIEF DESCRIPTION OF DRAWINGS

FIG. 1 is a diagram outlining backscattered light arisen at two points of an optical fiber.

FIG. 2 illustrates a configuration example of a measurement system of the present disclosure.

FIG. 3 illustrates an example of time waveforms of beat signals.

FIG. 4 is a diagram explaining frequency modulation by an instantaneous frequency.

FIG. 5 illustrates an example of a backscattered light waveform r(τ).

FIG. 6 illustrates an example of cross-correlation between frequency modulation amounts.

FIG. 7 illustrates an example of an analysis model of an optical fiber used in the present embodiment.

FIG. 8 illustrates an example of an analysis flow in an analysis device.

FIG. 9 illustrates an example of cumulative frequency modulation amounts.

FIG. 10 illustrates an example of cumulative frequency modulation amounts.

### DESCRIPTION OF EMBODIMENTS

Hereinafter, an embodiment of the present disclosure will be described in detail with reference to the drawings. Note that the present disclosure is not limited to the embodiments described below. These embodiments are merely exemplifications, and the present disclosure can be carried out in forms with various changes and improvements on the basis of the knowledge of those skilled in the art. Note that components having the same reference numerals in the present specification and the drawings denote the same components.

In optical frequency domain reflectometry (OFDR), there is no sampling theorem for strain and temperature as in OTDR-DAS. Therefore, any length of an analysis section for analyzing a frequency modulation difference can be set. Therefore, the present disclosure uses OFDR to measure at least one of strain caused by physical vibration of an optical fiber and temperature of the optical fiber in an analysis section. Hereinafter, an example of measuring strain, out of strain and temperature, will be described.

The inventors have found that frequency modulation can be measured by measuring the backscattered light waveform using OFDR and analyzing the time series of the backscattered light waveform by cross-correlation (see, for example, Non Patent Literature 2). The present disclosure is an application of this technique.

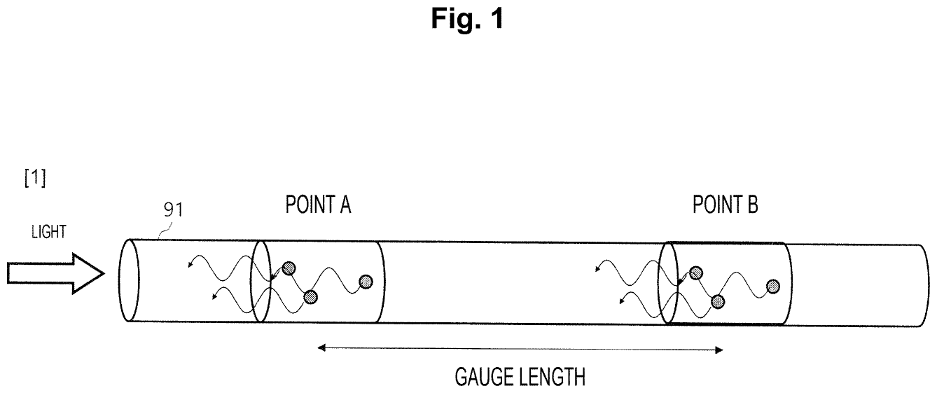

In the present disclosure, as illustrated in FIG. 1, in order to analyze a frequency modulation amount of probe light propagated through a freely-selected analysis section of an optical fiber 91, frequency modulation generated during transmission of the probe light from an injection end to point A and point B is analyzed using the technique of Non Patent Literature 2, and a difference in frequency modulation between the two points is obtained. Thus, the present disclosure analyzes the frequency modulation generated during transmission of the probe light between point A and point B.

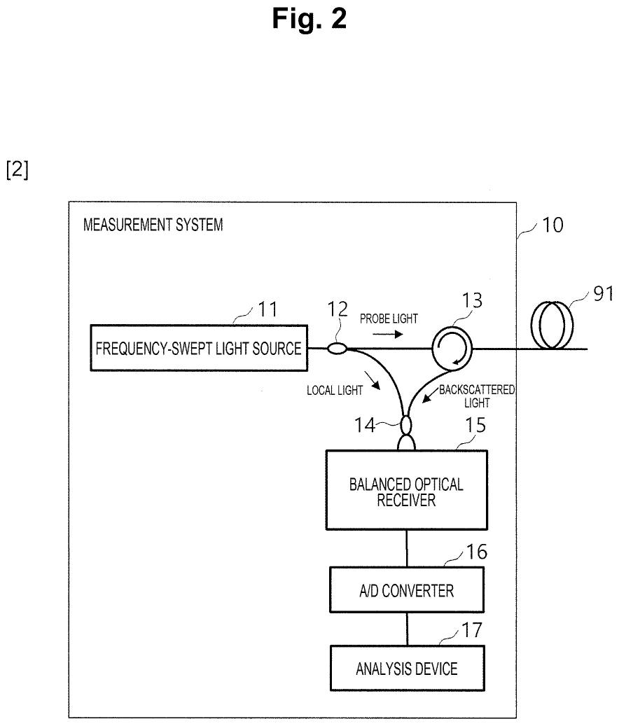

FIG. 2 illustrates a configuration example of a measurement system of the present disclosure. A measurement system 10 can be any means capable of measuring backscattered light of the optical fiber 91 using OFDR. For example, the measurement system 10 includes a frequency-swept light source 11, a coupler 12 functioning as an optical splitting part, a circulator 13, a coupler 14 functioning as an optical combining part, a balanced optical receiver 15, an A/D converter 16, and an analysis device 17.

The analysis device 17 functions as the analysis device of the present disclosure, and executes an analysis method of the present disclosure. The analysis device 17 can also be achieved by a computer and a program, and the program can be recorded in a recording medium or provided through a network. A program of the present disclosure is a program for implementation on a computer as each functional unit included in the analysis device 17 according to the present disclosure and is a program for directing a computer to execute each step included in a method executed by the analysis device 17 according to the present disclosure.

The frequency-swept light from the frequency-swept light source 11 is split at the coupler 12 to probe light entering the circulator 13, on one hand, and to local light entering the coupler 14, on the other hand. The circulator 13 lets the probe light be injected into the optical fiber 91 and emits backscattered light from the optical fiber 91 to the coupler 14. The coupler 14 combines the local light from the coupler 12 and the backscattered light from the circulator 13. As a result, a beat signal of the local light and the backscattered light is generated.

The balanced optical receiver 15 outputs an I component and a Q component of the backscattered light using the combined light from the coupler 14. The A/D converter 16 converts the I component and the Q component of the backscattered light into respective digital signals thereof. The analysis device 17 calculates the time waveform of the beat signal using the I component and the Q component of the backscattered light.

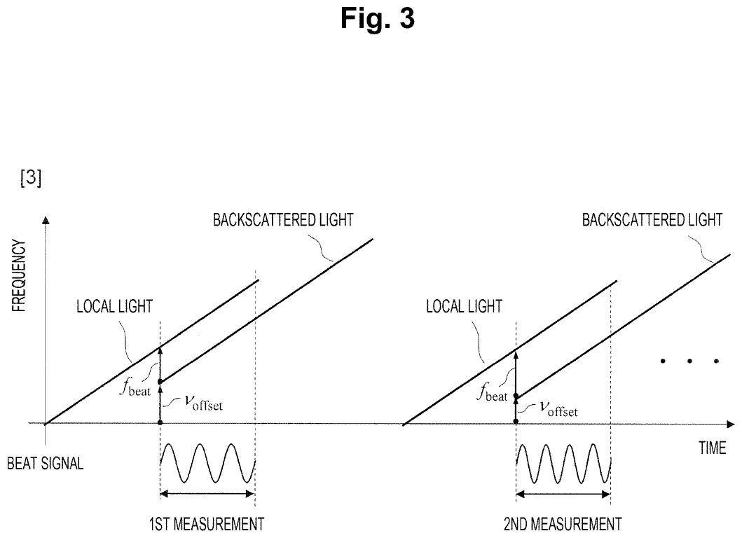

FIG. 3 illustrates an example of time waveforms of beat signals. In the present embodiment, as an exemplification, an example in which backscattered light is measured twice at different times will be described. Each piece of backscattered light includes a beat frequency f_{beat} and a frequency offset ν_{offset} caused by strain, which are based on the local light.

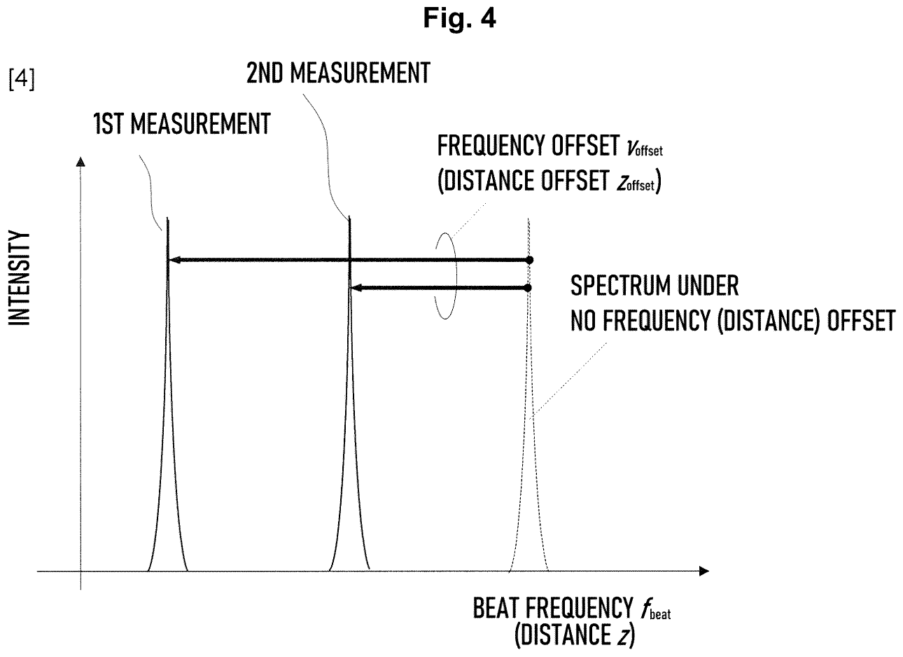

FIG. 4 illustrates an example of a spectrum in a beat frequency (distance) region. When the frequency sweep time of the probe light is sufficiently shorter than the inverse of the frequency modulation caused by strain, the instantaneous frequency caused by the strain modulates the mapping of the beat frequency of OFDR. Therefore, the beat frequency f_{beat} of OFDR is obtained by adding the frequency offset ν_{offset}, corresponding to the instantaneous frequency caused by strain, to a beat frequency f_{beat} under no modulation.

$$[ Math . 1 ]$$

$${f}_{beat} = γ \frac{2 z}{c} - {v}_{offset} = \frac{2 γ}{c} ( z - {z}_{offset} ) \qquad ( 1 )$$

$$[ Math . 2 ]$$

$${z}_{offset} = \frac{c}{2 γ} {v}_{offset} \qquad ( 2 )$$

Here, γ is a frequency sweep speed, z is a distance from an injection end of probe light, c is light speed, and z_{offset} is a distance offset corresponding to the frequency offset ν_{offset}.

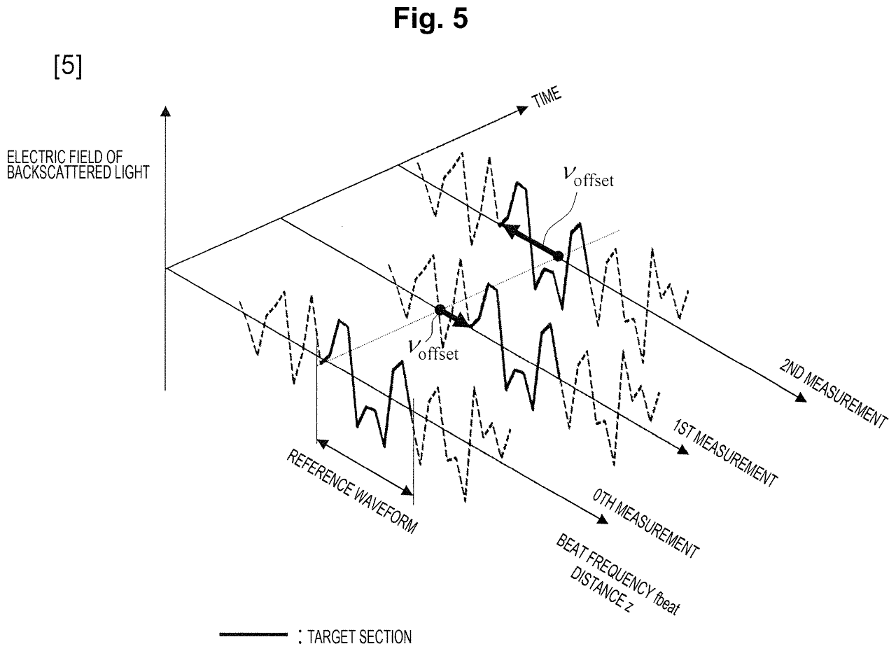

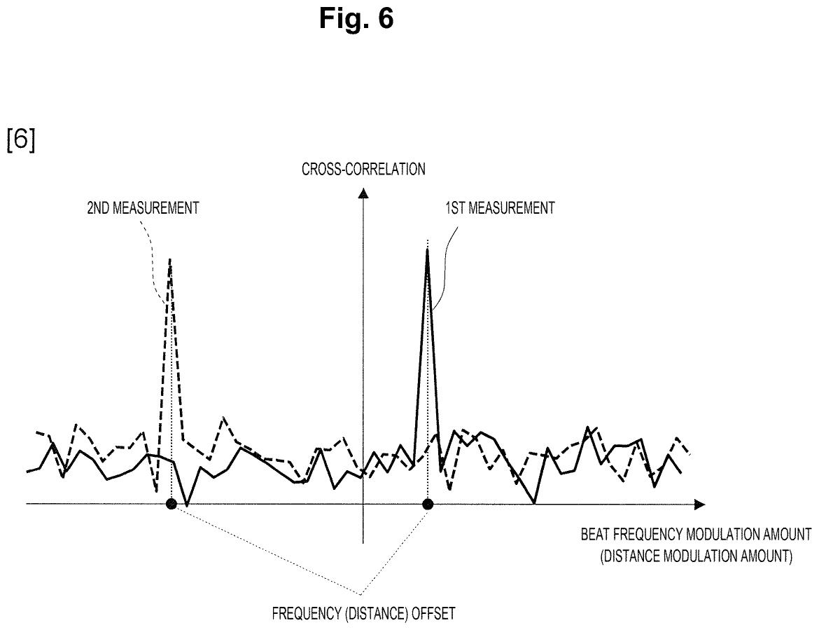

As illustrated in FIG. 5, the frequency offset ν_{offset} corresponding to the frequency modulation amount of the mapping is obtained by a cross-correlation signal based on a backscattered light waveform r(τ) existing at a certain time as a reference waveform. Therefore, the time series of the backscattered light waveform r(τ) is analyzed by cross-correlation based on the reference waveform. Then, as illustrated in FIG. 6, the offset of the frequency modulation amount, giving the peak of the cross-correlation, is calculated. Therefore, the frequency offset ν_{offset} based on the reference waveform can be measured.

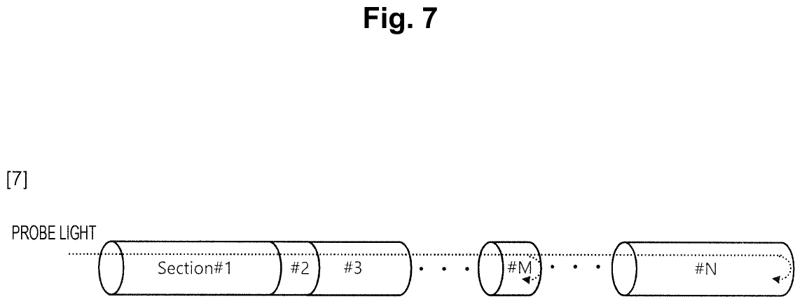

FIG. 7 illustrates an example of an analysis model of the optical fiber 91 used in the present embodiment. In the present embodiment, the optical fiber 91 is treated as a set of N sections serially named section #1 to section #N. Since a frequency modulation amount added in the optical fiber 91 is accumulated, the cumulative frequency modulation amount of the analysis section, connecting two different points, can be obtained by calculating the difference in frequency offset ν_{offset}. Therefore, strain caused by vibration of the analysis section, connecting the two different points, can be calculated.

Specifically, given that the frequency modulation amount of section #i is fᵢ(t), a cumulative frequency modulation amount F_{M}(t) obtained from sections #1 to #M and a cumulative frequency modulation amount F_{N}(t) obtained from sections #1 to #N are expressed by the formulae described below.

$$[ Math . 3 ]$$

$${F}_{M} ( t ) = {{\sum }_{j = 1}}^{M} {f}_{j} ( t ) \qquad ( 3 )$$

$$[ Math . 4 ]$$

$${F}_{N} ( t ) = {{\sum }_{i = 1}}^{N} {f}_{i} ( t ) \qquad ( 4 )$$

A cumulative frequency modulation amount F_{N-M}(t) obtained from sections #M+1 to #N is expressed by the formula described below.

$$[ Math . 5 ]$$

$${F}_{N - M} ( t ) = {F}_{N} ( t ) - {F}_{M} ( t ) = {{\sum }_{k = M + 1}}^{N} {f}_{k} ( t ) \qquad ( 5 )$$

A strain amount ε_{N-M}(t), corresponding to the cumulative frequency modulation amount F_{N-M}(t) obtained from sections #M+1 to #N, is expressed by the formula described below.

$$[ Math . 6 ]$$

$${F}_{N - M} ( t ) = \frac{1}{2 π} \frac{d {θ}_{N - M}}{dt} = \frac{1}{2 π} \frac{d}{dt} ( k 2 {nL}_{N - M} ε ( t ) ) \qquad ( 6 )$$

$$[ Math . 7 ]$$

$${ε}_{N - M} ( t ) = \frac{λ}{2 {nL}_{N - M}} \int {F}_{N - M} ( t ) dt \qquad ( 7 )$$

Here, the parameters are as described below.
θ_{N-M}: Phase obtained from sections #M+1 to #N
k: Wavenumber
n: Refractive index
λ: Wavelength
L_{N-M}: Length from sections #M+1 to #N

### (Analysis Flow)

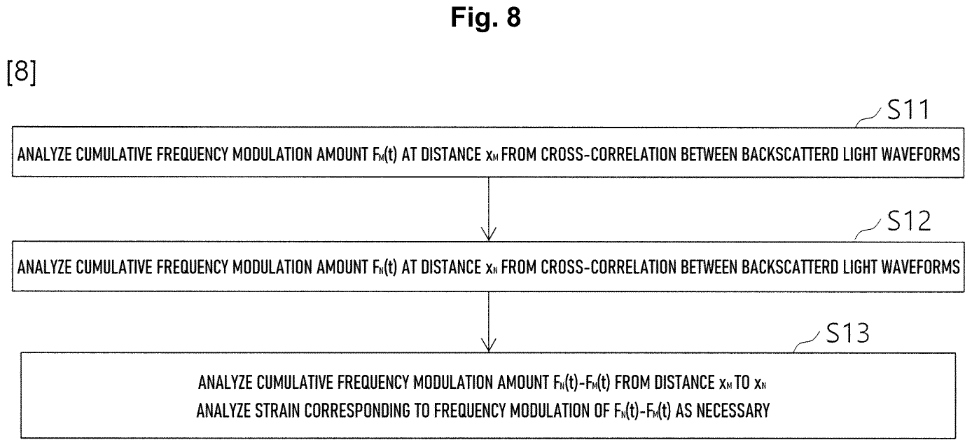

FIG. 8 illustrates an example of an analysis flow in the analysis device 17. As illustrated in FIG. 5, the backscattered light waveform r(τ) of the optical fiber 91 is repeatedly measured, and then the frequency modulation amounts F_{M}(t) and F_{N}(t) existing at freely-selected two points located at distances x_{M} and x_{N} from the injection end of the probe light are calculated (S11 and S12).

The frequency modulation of the analysis section between the freely-selected two points is obtained by subtracting the cumulative frequency modulation amounts F_{M}(t) and F_{N}(t) existing at the two points subjected to the analysis (S13).

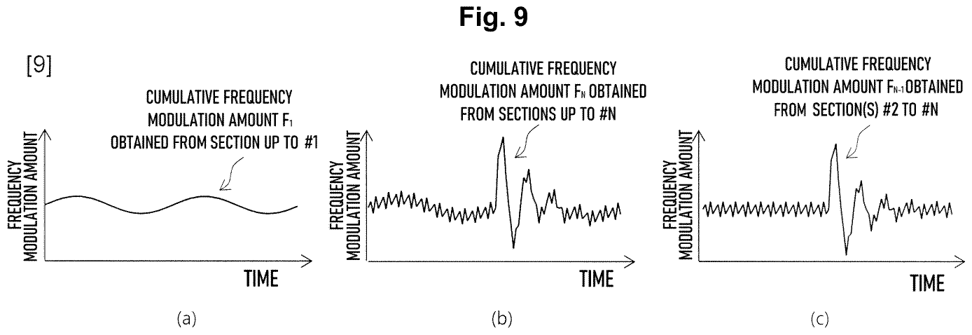

For example, a cumulative frequency modulation amount F₁(t) obtained from a section up to #1 as illustrated in FIG. 9(a) can be calculated, by calculating the frequency offset ν_{offset} of section #1 using a plurality of backscattered light waveforms r(τ) existing at different times, in step S11.

For example, a cumulative frequency modulation amount F_{N}(t) obtained from a series from section #1 to section #N as illustrated in FIG. 9(b) can be calculated, by calculating the frequency offset ν_{offset} of section #N using a plurality of backscattered light waveforms r(τ) existing at different times, in step S12. In the example of FIG. 9(b), impulse-like frequency modulation occurs between sections #1 and #N.

Then, in step S13, a difference between the cumulative frequency modulation amount F_{N}(t) and the cumulative frequency modulation amount F₁(t) is calculated. In accordance with this, as illustrated in FIG. 9(c), the cumulative frequency modulation amount obtained from sections #2 to #N can be calculated. Referring to FIG. 9(c), the impulse-like frequency modulation remains. The analysis device 17 can determine occurrence of the impulse-like frequency modulation between sections #2 and #N by using the result of step S13. In addition, the analysis device 17 can calculate a strain amount ε_{N-1}(t) between sections #2 and #N by using the result of step S13, for example, by using Formula (8).

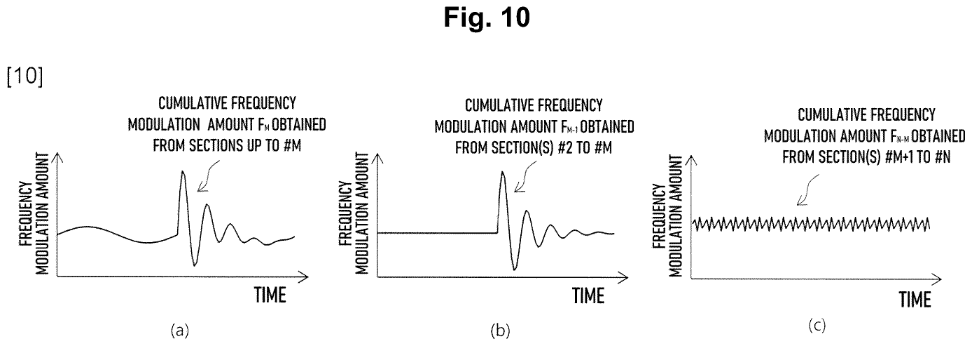

The present disclosure can be applied to a search for an origin of vibration on the basis of an increase or decrease in cumulative frequency modulation amount in an analysis section. The following example is considered: when the cumulative frequency modulation amount F_{M}(t) obtained from sections #1 to #M is calculated by calculating the frequency offset ν_{offset} of section #M, the result shows that the impulse-like frequency modulation occurs as illustrated in FIG. 10(a).

The analysis section is narrowed by changing section #1, which is one of the points of the analysis section, to section #2, and the cumulative frequency modulation amount F_{M-1}(t) obtained from a series from section #2 to section #M is calculated. The result shows that, as illustrated in FIG. 10(b), impulse-like frequency modulation occurs.

When the analysis section is modified by changing both sections, and the cumulative frequency modulation amount F_{N-M}(t) obtained from a series from section #M+1 to section #N is calculated, as illustrated in FIG. 10(c), the cumulative frequency modulation amount decreases, which shows that the impulse-like frequency modulation does not occur. This shows that the impulse-like frequency modulation occurs between sections #2 and #M. In this manner, the present disclosure can analyze the cumulative frequency up to an intermediate point and discover an origin of the vibration on ground of an increase or decrease in cumulative frequency modulation amount.

Note that a point on the backscattered light waveform r(τ) as illustrated in FIG. 5 can be associated with a position on the optical fiber 91 using the beat frequency of the local light and the backscattered light. For example, as in Formula (1), when the frequency offset ν_{offset} does not exist, the beat frequency is given by f_{beat}=γ(2z/c). Since f_{beat} and a distance z are associated with the frequency sweep speed γ, which is a measurement condition, as a proportional constant, the distance z can be determined from the beat frequency f_{beat}.

### (Effects of Present Disclosure)

In the present disclosure, an analysis section length for calculating a difference in cumulative frequency modulation amount between two points may be long. Therefore, an origin of vibration existing at any position of the optical fiber 91 can be discovered.

A method of measuring strain caused by vibration applied between two points or temperature of an optical fiber by finding a difference in measurement result between the two points is mainly used in OTDR, but the present disclosure adopts this method in OFDR. In OTDR, the maximum temporal change amount of the measurable strain has limitation depending on the distance (gauge length) between two points due to the phase unwrapping condition, but in OFDR, the maximum temporal change amount has no limitation depending on the distance between two points. Therefore, the present disclosure has an advantageous effect that the distance between two points can be freely set.

Accordingly, in the present disclosure, the distance between two points can be freely set, in the means for measuring at least one of the physical vibration applied to the optical fiber and the temperature of the optical fiber in a distributed manner in the longitudinal direction of the optical fiber.

### REFERENCE SIGNS LIST

11 Frequency-swept light source
12, 14 Coupler
13 Circulator
15 Balanced optical receiver
16 A/D converter
17 Analysis device
91 Optical fiber

1. An analysis device that analyzes beat signals obtained by combining backscattered light from an optical fiber obtained by injection of probe light, out of the probe light and local light obtained by split of frequency-swept light, into the optical fiber, with the local light,
wherein
the analysis device
calculates frequency offsets existing at two different points of the optical fiber by using cross-correlation between backscattered light waveforms obtained from the beat signals measured at different times; and
measures strain or temperature of an analysis section, connecting the two different points, by calculating a difference between the frequency offsets existing at the two different points.

2. The analysis device according to claim 1, wherein the analysis device
calculates a cumulative frequency modulation amount of the analysis section connecting the two different points by calculating the difference between the frequency offsets existing at the two different points; and
calculates the strain or temperature using the calculated cumulative frequency modulation amount.

3. The analysis device according to claim 2, wherein
the analysis section is modified by changing a position of at least one of the two points of the optical fiber; and
an origin of vibration of the optical fiber is discovered on ground of an increase or a decrease in cumulative frequency modulation amount of the modified analysis section.

4. A measurement system comprising:
a frequency-swept light source that outputs frequency-swept light;
an optical splitting part that splits the frequency-swept light into probe light and local light;
an optical combining part that combines backscattered light obtained by injection of the probe light into the optical fiber with the local light; and
the analysis device according to claim 1 that analyzes a beat signal obtained by the combination.

5. An analysis method executed by an analysis device that analyzes distribution waveforms of beat signals obtained by combining backscattered light from an optical fiber obtained by injection of probe light, out of the probe light and local light obtained by split of frequency-swept light, into the optical fiber, with the local light, the analysis method comprising:
calculating frequency offsets existing at two different points of the optical fiber by using cross-correlation between backscattered light waveforms obtained from the beat signals measured at different times; and
measuring strain or temperature of an analysis section, connecting the two different points by calculating a difference between the frequency offsets existing at the two different points.

6. A non-transitory storage medium containing a program for implementation on a computer as the analysis device according to claim 1.
